(19) United States
(12) Patent Application Publication
(10) Pub. No.: US 2006/0098707 A1
(43) Pub. Date: May 11, 2006

(54) Method for fabricating laser diode with oxidation barrier layers

(75) Inventor: Young-Churl Bang, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/180,776

(22) Filed: Jul. 13, 2005

(30) Foreign Application Priority Data
Nov. 10, 2004 (KR) 2004-91243

(51) Int. Cl. H01S 3/097

(52) U.S. Cl. 372/83

(57) ABSTRACT

A method of manufacturing a laser diode having an active layer made from semiconductor substances containing aluminum is disclosed. The method comprises the steps of forming a first mask, which has first and second slits spaced apart from each other, on a substrate, forming first and second oxidation barrier layers, which are limited by the first and second slits, on the substrate through selective area growth (SAG) using the first mask, and forming a plurality of layers including the active layer containing aluminum between the first and second oxidation barrier layers on the substrate.

### CLAIM of PRIORITY

This application claims priority under 35 U.S.C. § 119 to that patent application entitled “Method for Fabricating Laser Diode with Oxidation Barrier Layers,” filed in the Korean Intellectual Property Office on Nov. 10, 2004 and assigned Serial No. 2004-91243, the contents of which are incorporated herein by reference.

### BACKGROUND OF THE INVENTION

1. Field of the Invention

The present invention relates to laser diode fabrication and in particular, to a method of preventing aluminum oxidation in the manufacturing process of a laser diode having an active layer of semiconductor substances containing aluminum.

2. Description of the Related Art

A ridge waveguide laser diode (RWG-LD), one of well-known laser diodes, has many advantages in that its manufacture is relatively simple, it operates in a single mode, and its connection with an external waveguide is relatively straightforward.

The RWG-LD is an already disclosed technology. For example, a RWG-LD having a double hetero-structure and a strip-shaped ridge waveguide is disclosed in U.S. Pat. No. 4,352,187 entitled “Semiconductor Laser Diode” filed by and issued to Amann.

FIG. 1 is a sectional diagram of a typical AlGaInAs RWG-LD 100. Referring to FIG. 1, the RWG-LD 100 is obtained by sequentially forming an InP buffer layer 120, an AlGaInAs lower waveguide layer 130, an AlGaInAs active layer 140 having a multiple quantum well (MQW) structure, an AlGaInAs upper waveguide layer 150 and a p-doped in P clad layer 160 on an InP substrate 110. The laser diode shown operates in a manner that the active layer 140 generates a light, the lower and upper waveguide layers 130 and 150 guide the generated light, the buffer layer 120 and the clad layer 160 trap the light within the active layer 140 and the lower and upper waveguide layers 130 and 150.

However, since the active layer 140 and lower and upper waveguide layers 130 and 150 in the typical RWG-LD 100 are made from semiconductor substances containing aluminum, oxidation of the this material occurs on the facets (or interfaces) 170 and 175 of the aluminum-contained layers 130, 140 and 150. Such oxidation is detrimental as it may cause catastrophic optical damage (COD).

### SUMMARY OF THE INVENTION

An object of the present invention is to substantially solve at least the above problems and/or disadvantages and to provide at least the advantages below. Accordingly, an object of the present invention is to provide a laser diode manufacturing method preventing aluminum oxidation from occurring on the facets of layers containing aluminum.

According to one aspect of the present invention, there is provided a method of manufacturing a laser diode having an active layer made from semiconductor substances containing aluminum, the method comprising the steps of forming a first mask, which has first and second slits spaced apart from each other, on a substrate, forming first and second oxidation barrier layers, which are limited by the first and second slits, on the substrate through selective area growth (SAG) using the first mask and forming a plurality of layers including the active layer containing aluminum between the first and second oxidation barrier layers on the substrate.

### BRIEF DESCRIPTION OF THE DRAWINGS

The above features and advantages of the present invention will become more apparent from the following detailed description when taken in conjunction with the accompanying drawings in which:

FIG. 1 is a sectional diagram of a typical AlGaInAs RWG-LD;

FIG. 2 is a sectional diagram of an RWG-LD having oxidation barrier layers according to a preferred embodiment of the present invention; and

FIGS. 3 to 10 collectively illustrate a method of manufacturing an RWG-LD having oxidation barrier layers according to a preferred embodiment of the present invention.

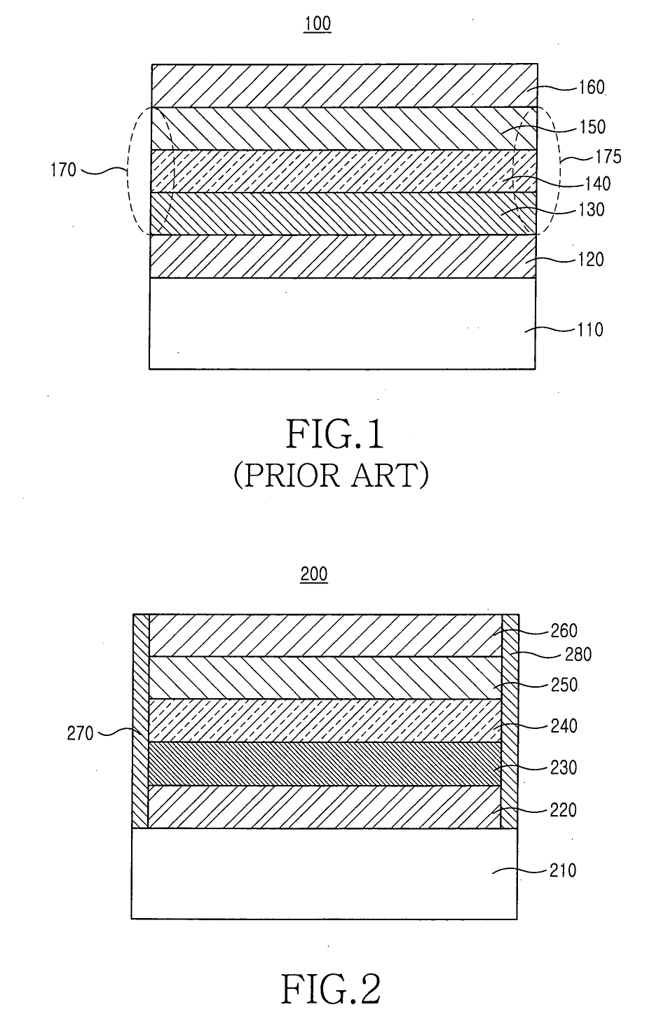

### DETAILED DESCRIPTION

Embodiments of the present invention will be described herein below with reference to the accompanying drawings. For the purposes of clarity and simplicity, well-known functions or constructions are not described in detail as they would obscure the invention in unnecessary detail.

FIG. 2 is a sectional diagram of a ridge waveguide laser diode (RWG-LD) 200 having oxidation barrier layers according to a preferred embodiment of the present invention. Referring to FIG. 2, the RWG-LD 200 is obtained by sequentially forming an InP buffer layer 220, an AlGaInAs lower waveguide layer 230, an AlGaInAs active layer 240 having a multiple quantum well (MQW) structure, an AlGaInAs upper waveguide layer 250 and a p-doped InP clad layer 260 on an InP substrate 210 and forming first and second InP oxidation barrier layers 270 and 280 on both facets (or interfaces) of each of buffer layer 220, lower and upper waveguide layers 230 and 250, active layer 240 and clad layer 260. The active layer 240 generates light, the lower and upper waveguide layers 230 and 250 guide the generated light, the buffer layer 220 and the clad layer 160 trap the light within the active layer 240 and the lower and upper waveguide layers 230 and 250. The first and second oxidation barrier layers 270 and 280 prevent aluminum oxidation by isolating both facets of the aluminum-contained layers 230, 240 and 250 from the surrounding air. The first and second oxidation barrier layers 270 and 280 may be made from other semiconductor substances in which aluminum is not contained.

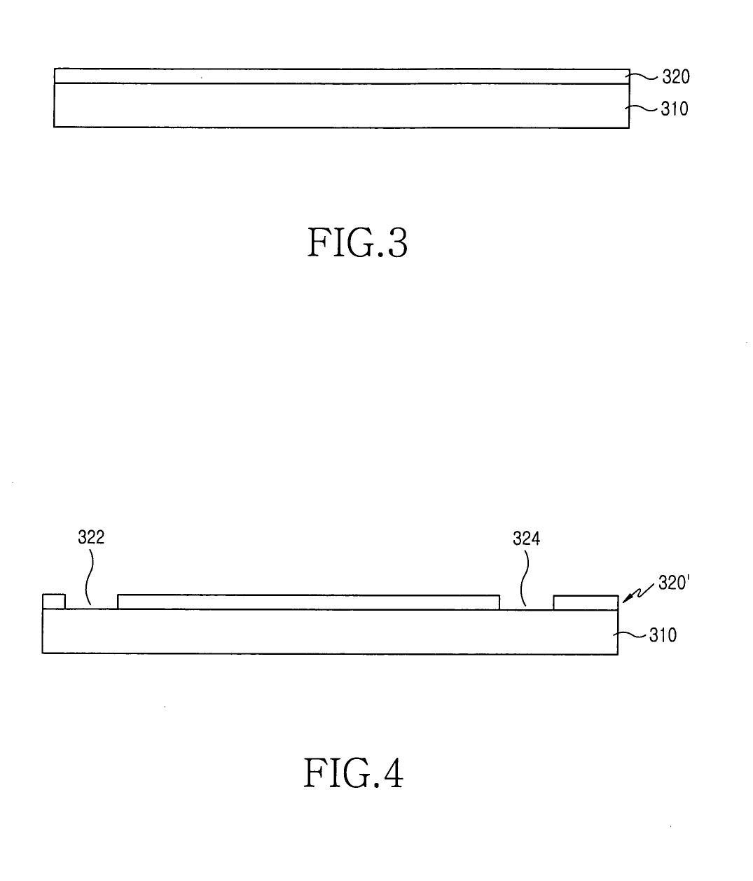

FIGS. 3 to 10 are diagrams illustrating a method of manufacturing an RWG-LD having oxidation barrier layers according to a preferred embodiment of the present invention. The manufacturing method includes steps referred to as (a) to (d), which are more fully described below. Although the manufacturing method is described with regard to a sequential order, it would be recognized that the order shown describes only one sequence contemplated to be within the scope of the invention. However, it appreciated that all the steps described herein need not be performed or need be performed in the sequence described to obtain a benefits disclosed.

A first step in the method, referred to as step (a), is a process of forming a first mask, which has first and second slits spaced apart from each other, on a substrate. Step (a) includes sub-steps (a-1) and (a-2).

FIG. 3 illustrates an exemplary embodiment of forming a first mask wherein sub-step, referred to as step (a-1), represents a process of forming an SiO₂ first layer 320 on an InP substrate 310.

FIG. 4 illustrates an exemplary embodiment of forming a first mask wherein a second sub-step in the method, referred to as step (a-2), represents a process of forming a firstmask 320′ by etching the first layer 320 so that the first layer 320 has rectangular-shaped first and second slits 322 and 324 spaced apart from each other by a distance corresponding to a cavity length of the RWG-LD, using photolithography in which a photoresist material is used. In one aspect of the invention, the cavity length may be of the order 300 microns (μm).

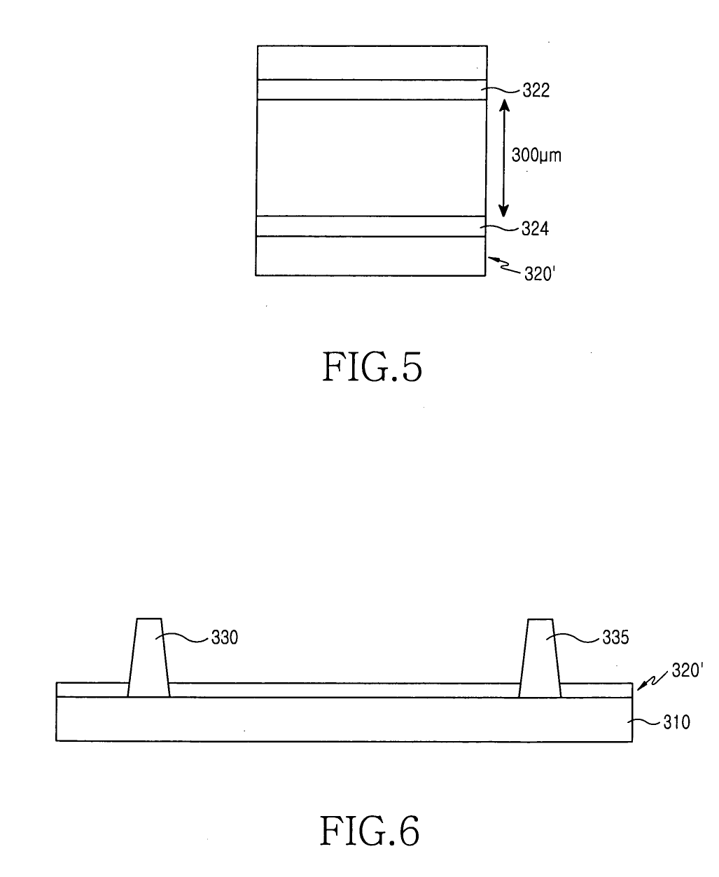

FIG. 5 illustrates a top view of FIG. 4, wherein each of the first and second slits 322 and 324 is laid across both ends of the substrate 310 and has a rectangular shape with a predetermined width.

FIG. 6 illustrates an exemplary embodiment of a step in the method, referred to as (b), which represents a process of forming InP first and second oxidation barrier layers 330 and 335 on the substrate 310 through selective area growth (SAG) using the first mask 320′.

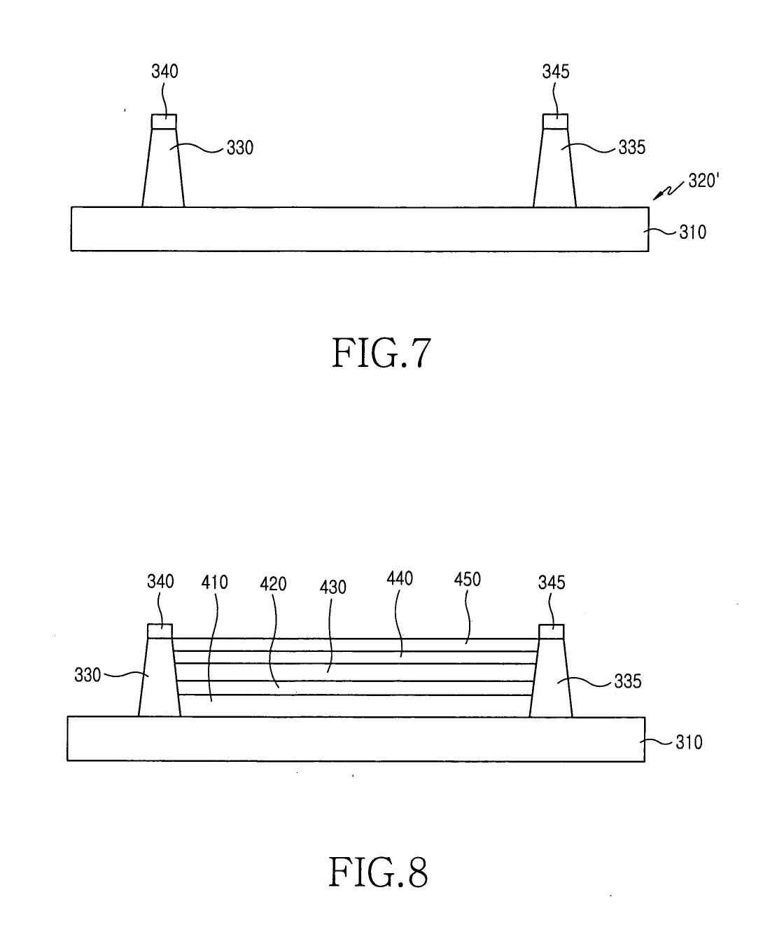

FIG. 7 illustrates an exemplary embodiment of a next step in the method, referred to as (c), which represents a process of removing the first mask 320′ on the substrate 310 and forming SiO₂ second masks 340 and 345 on corresponding first and second oxidation barrier layers 330 and 335.

FIG. 8 illustrates an exemplary embodiment of a next step in the method, referred to as step (d), which represents a process of sequentially forming an InP buffer layer 410, an AlGaInAs lower waveguide layer 420, an AlGaInAs active layer 430 having the MQW structure, an AlGaInAs upper waveguide layer 440 and a p-doped InP clad layer 450 on the substrate 310 between the first and second oxidation barrier layers 330 and 335 through the SAG

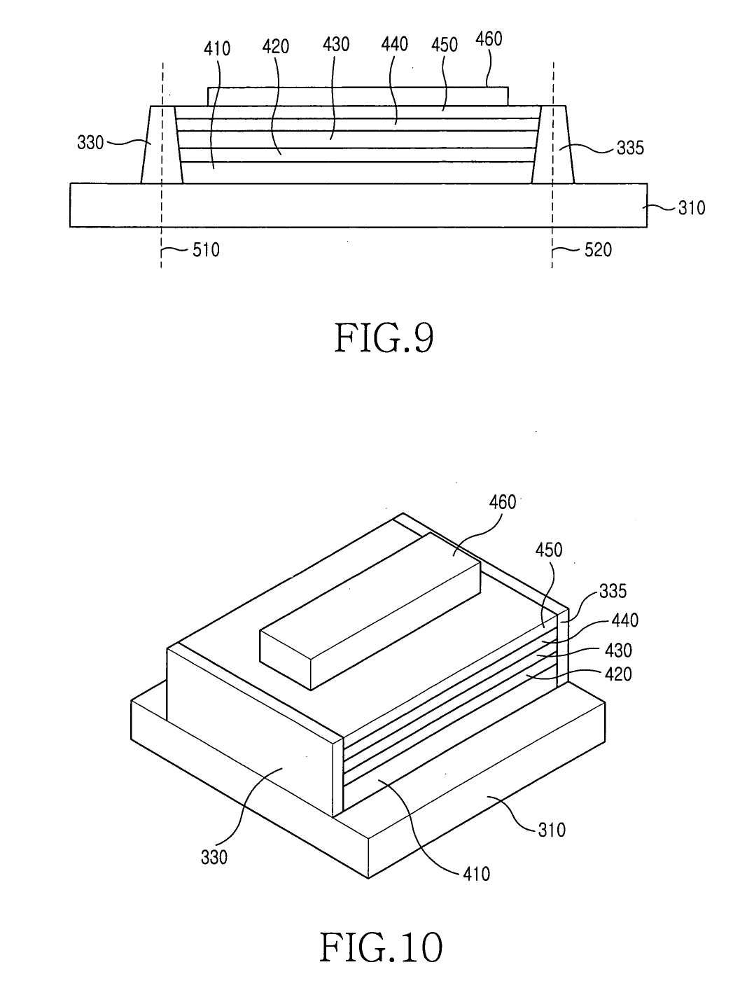

FIG. 9 illustrates an exemplary embodiment of a next step in the method, referred to as step (e), which represents a process of removing the second masks 340 and 345 and forming an electrode 460 on the clad layer 450.

FIG. 10 illustrates an exemplary embodiment of a next step in the method, referred to as (f), which represents a process of cleaving the structure shown in FIG. 9 chip by chip, i.e., cleaving the structure along a first cleaving line 510 (see FIG. 9), which equally divides the first oxidation barrier layer 330 into two in a width direction, and a second cleaving line 520 (see FIG. 9), which equally divides the second oxidation barrier layer 335 in the width direction.

As described above, according to a laser diode manufacturing method according to the embodiment of the present invention, aluminum oxidation can be prevented by isolating both facets of layers containing aluminum from the air by forming first and second oxidation barrier layers on the corresponding facets.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of manufacturing a laser diode having an active layer made from semiconductor substances containing aluminum, the method comprising the steps of:
(a) forming a first mask, which has first and second slits spaced apart from each other, on a substrate;
(b) forming first and second oxidation barrier layers, which are limited by the first and second slits, on the substrate through selective area growth (SAG) using the first mask; and
(d) forming a plurality of layers including the active layer containing aluminum between the first and second oxidation barrier layers on the substrate.

2. The method of claim 1, further comprising, the step of:
(c) forming second masks on the first and second oxidation barrier layers.

3. The method of claim 1, wherein in the step (d), further comprises the steps of:
removing the first mask, and
depositing, sequentially, a plurality of layers forming a laser diode on the substrate through SAG between the first and second oxidation barrier layers

4. The method of claim 1, wherein the step (a) comprises the steps of:
(a-1) forming a first layer on the substrate; and
(a-2) forming the first mask by etching the first layer so that the first layer has first and second slits spaced apart from each other by a predetermined distance.

5. The method of claim 1, further comprising the step of:
(f) cleaving the first oxidation barrier layer along a first cleaving line, and the second barrier layer along a second cleaving line.

6. The method of claim 1, wherein the first and second oxidation barrier layers are made from semiconductor substances in which aluminum is not contained.

7. The method of claim 3, wherein the plurality of layers disposed between the first and second oxidation barrier layers comprises an active layer for generating light, lower and upper waveguide layers for guiding the generated light, and a buffer layer and a clad layer for trapping the light within the active layer and lower and upper waveguide layers.

8. The method of claim 1, further comprising the step of:
(e) forming an electrode for supplying a current on at least one layer of the plurality of layers.

9. The method of claim 8, further comprising the step of:
(f) cleaving the first oxidation barrier layer along a first cleaving line, and the and second barrier layer along a second cleaving line.

10. A laser diode comprising:
a first and a second barrier layer formed substantially vertical and oppositely opposed on a substrate a predetermined distance apart; and
a plurality of layers deposited on the substrate between the first and second barrier layers, wherein the plurality of layers comprise:
an active layer for generating light, lower and upper waveguide layers surrounding the active layer for guiding the generated light, and
a buffer layer and a clad layer surrounding the lower and upper waveguide layers, respectively, for trapping the light within the active layer and lower and upper waveguide layers, wherein the barrier layers are formed of a material not containing aluminum.

11. The diode of claim 10, wherein the first and second barrier layers are cleaved along a first and second cleave line, respectively.
